(19) United States
(12) Patent Application Publication
(10) Pub. No.: US 2026/0039572 A1
(43) Pub. Date: Feb. 5, 2026

(54) DYNAMIC NETWORK TRAFFIC ANALYSIS FOR ANOMALY

(71) Applicant: HEWLETT PACKARD ENTERPRISE DEVELOPMENT LP, Spring, TX (US)

(72) Inventors: Tathagata Nandy, Bangalore (IN); Yamini Krishna Sekuri, Bangalore (IN); Vinay Kumar Vishwakarma, Bangalore (IN)

(21) Appl. No.: 18/897,902

(22) Filed: Sep. 26, 2024

(30) Foreign Application Priority Data
Jul. 31, 2024 (IN) 202441057945

(51) Int. Cl. H04L 43/028; H04L 43/08

(52) U.S. Cl. CPC H04L 43/028; H04L 43/08

(57) ABSTRACT

A network device is provided. During operation, the network device determines the device type of a respective user device associated with the network device. The network device monitors a movement pattern of the user device indicating the number of times the network device has learned its layer-2 address within a period. The network device also monitors a traffic pattern indicating the type and volume of traffic of the user device. The network device determines whether their combination matches an anomalous operation. If it matches, the network device selects a traffic filter mapped to the anomalous operation and applies the traffic filter to select a corresponding subset of traffic. The network device then selects, from a set of target devices, a target device based on a volume of the subset of the traffic and mirrors it to the target device, which can facilitate analysis of the subset of the traffic.

### BACKGROUND

A network device, such as a switch, may couple different types of user devices (or end devices), such as the Internet of Things (IoT) devices and personal devices (e.g., laptops and tablets). To facilitate connectivity to these devices, the network device may support different protocols and services.

### BRIEF DESCRIPTION OF THE FIGURES

FIG. 1A illustrates an example of a network supporting dynamic anomaly detection and filtering for traffic mirroring, in accordance with an aspect of the present application.

FIG. 1B illustrates an example of a network supporting dynamic selection of a target device for mirrored traffic, in accordance with an aspect of the present application.

FIG. 2 illustrates an example of a mapping data structure for supporting dynamic anomaly detection and filtering, in accordance with an aspect of the present application.

FIG. 3 presents a flowchart illustrating an example of a process of a network device facilitating dynamic network traffic analysis, in accordance with an aspect of the present application.

FIG. 4 presents a flowchart illustrating an example of a process of a network device dynamically detecting an anomalous operation, in accordance with an aspect of the present application.

FIG. 5 presents a flowchart illustrating an example of a process of a network device dynamically selecting a target device for mirrored traffic, in accordance with an aspect of the present application.

FIG. 6 illustrates an example of a computing system facilitating dynamic network traffic analysis, in accordance with an aspect of the present application.

FIG. 7 illustrates an example of a computer-readable medium (CRM) facilitating dynamic network traffic analysis, in accordance with an aspect of the present application.

In the figures, like reference numerals refer to the same figure elements.

### DETAILED DESCRIPTION

A set of network devices can be coupled to each other to form a network. The network can include different types of network devices, such as access network devices (or access devices) and core network devices (or core devices). Access devices can couple end devices (e.g., user devices), thereby facilitating access to the network. Moreover, core devices can be coupled to network devices of other networks to facilitate communication outside of the network. The access devices may couple different types of end devices, such as IoT devices and personal devices. Because many of these devices may require low-bandwidth data flows, a respective access device may serve a large number of these devices.

Any of these end devices and network devices may behave anomalously due to a misconfiguration or security compromise. Typically, such an anomalous behavior is detected when a corresponding network issue is observed. For example, the network issue can include packet loss for one or more end devices. Based on the packet loss, a network administrator can determine the source and destination addresses (e.g., Internet Protocol (IP) addresses) and determine the corresponding data flows. The network administrator can then determine the data paths used by these data flows using different networking tools. The network administrator may set one or more traffic mirroring filters, which can then mirror traffic from the devices on the paths to a predetermined target device, such as a network management system (e.g., a network orchestrator). Subsequently, the network administrator can analyze the mirrored traffic to determine the cause of the anomaly.

The aspects described herein address the problem of efficiently mirroring traffic associated with anomalous behavior by (i) determining whether a combination of a device type, movement pattern, and traffic pattern of an end device indicates an anomalous operation; (ii) upon detecting the anomalous operation, applying a traffic filter mapped to the combination to determine which traffic to mirror; and (iii) selecting a target device from a set of target devices to mirror the selected traffic. As a result, a network device may detect the anomaly before it triggers the corresponding issue (e.g., packet loss). Furthermore, based on the type and volume of mirrored traffic, the network device may dynamically select the target device to which the mirrored traffic is to be forwarded. In this way, the network device can dynamically analyze network traffic for anomaly detection and mirror corresponding traffic to a corresponding target device.

Currently, a network may support a large number of user devices (e.g., IoT devices, laptops, and tablets). Typically, the processing resources of IoT devices can be limited. Hence, many of these devices may not have sophisticated security measures and can be compromised. Furthermore, some of these devices may also be misconfigured. Consequently, these devices may operate anomalously and may generate high volumes of anomalous traffic. Such anomalous operations may cause issues, such as packet loss due to overutilization of resources and network delays due to extensive queueing.

Existing anomaly detection tools typically detect these issues in the network but not the anomalous operations leading to the issue. Consequently, prior to detecting the issue, these tools may not be able to dynamically define a filter to identify a particular data flow or device performing anomalously. Once the issue is detected, these tools can mirror traffic of multiple data flows from a network device and forward the mirrored traffic to a target device (e.g., a network manager or a virtual machine (VM)). Furthermore, many such tools rely on an administrator to select the data flows for mirroring. Therefore, the traffic mirroring operation may not be dynamically initiated before the issue is detected and may not be specific to the data flow causing the issue.

At the target device, a network administrator may analyze a substantial volume of network traffic to identify the cause of the issue, which can be tedious and error prone. In addition, the target device for a tool is typically predetermined. As a result, mirrored traffic related to all types of anomalies may be forwarded to a particular target device, which can be overutilized. For example, all anomalous traffic detected at a network device can be forwarded to a management device (e.g., the network orchestrator) for further analysis. Similarly, a current anomaly detection tool may mirror one or more flows to a predetermined security device. Consequently, the management device can become overwhelmed if multiple network devices start sending their traffic to it.

To address this problem, a respective network device of a network can be enhanced to perform dynamic traffic analysis. In some examples, the network device can be equipped with a traffic analysis tool that can perform dynamic traffic analysis. The network device can maintain a set of parameters associated with expected anomalous operations of user devices. These anomalous operations can correspond to atypical movement and packet-generation patterns of individual user device types. The parameters of a respective anomalous operation can then indicate the atypical movement and packet-generation patterns of a particular type of user device.

For example, if the user device is an IoT device, such as a smart appliance (e.g., a smart refrigerator or home security system), a movement pattern can be indicated by a monitoring parameter associated with a number of migrations within a period. The number of migrations can be determined based on the number of times the network device has learned the layer-2 address (e.g., the media access control (MAC) address) of the user device within the period. This parameter can then be compared with a condition parameter, such as a threshold set by an administrator. If the monitoring parameter exceeds the threshold, the movement pattern can be atypical since these IoT devices are mostly stationary. Similarly, the traffic pattern of a user device can indicate the type and volume of traffic generated by the user device. Hence, an atypical traffic pattern for the IoT device can be the generation of high-volume traffic (e.g., video streaming) since these devices are not used for such purposes.

The network device can store a mapping data structure (MDS) (e.g., a mapping table). The MDS can be stored in the forwarding hardware (e.g., in a ternary content addressable memory (TCAM)) of the network device. A respective entry of the MDS can map the parameters indicating an anomalous operation to a corresponding traffic filter. A respective filter can indicate which data flow, device, or traffic type to be filtered. The filter can be used to mirror traffic relevant to the anomalous operation. In other words, the filter can select the subset of traffic relevant to the anomalous operation from all traffic at the network device. During operation, the network device can monitor the monitoring parameters indicating the movement pattern and traffic at the network device. The network device can compare the monitoring parameters with the condition parameters. Based on the comparison, the network device can determine (or infer) atypical movement and traffic patterns of individual user device types.

For example, a condition parameter can indicate a threshold number of migrations. If a user device's migration, which can be determined by the corresponding monitoring parameter, exceeds the threshold, the network device can determine that the user device is migrating frequently (i.e., the movement pattern of the user device indicates frequent migration). Another condition parameter can indicate packet sizes generated by a user device. If the packet sizes of the user device, which can be determined by the corresponding monitoring parameter, are large (e.g., 1500 bytes of Ethernet payload), the network device can determine that the user device is generating high-volume traffic, such as video.

If the network device determines that the monitoring parameters associated with a user device indicate an atypical pattern for a device type, the network device can determine the corresponding anomalous operation. For example, if the user device is a multicast host (i.e., recipient of multicast data) with frequent migration, the network device can determine that the monitoring parameter of the movement pattern of the user device matches the condition parameters of an anomalous operation of the MDS. The network device can then select the filter mapped to the anomalous operation in the MDS and apply the filter to mirror the relevant subset of traffic to a corresponding target device. Here, the mirroring of the traffic selected by the filter can be initiated prior to detecting an issue with the network device (e.g., utilization of resources, delay, or packet drops at the network device). In this way, the network device can start traffic analysis of the relevant traffic during the anomalous operation before the issue has occurred.

The network device can dynamically select the target device from a set of available target devices. There can be different types of target devices in a network, such as the processing resources of the network device, a VM dedicated to traffic analysis, and the network management system (NMS). Examples of a processing resource can include, but are not limited to, a central processing unit (CPU), a graphical processing unit (GPU), and an accelerator. Here, the NMS can be a system via which the network can be monitored and configured, such as a network orchestrator. Based on the volume of mirrored traffic and the analysis requirement of the anomalous operation, the network device can dynamically select the target device. The analysis requirement can indicate whether extensive manual analysis of the mirrored traffic by an administrator is needed. The analysis requirement can be predetermined by the administrator and may be indicated in the corresponding entry in the MDS. By dynamically selecting the target device, the network device can efficiently perform network traffic analysis without overwhelming an individual target device.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

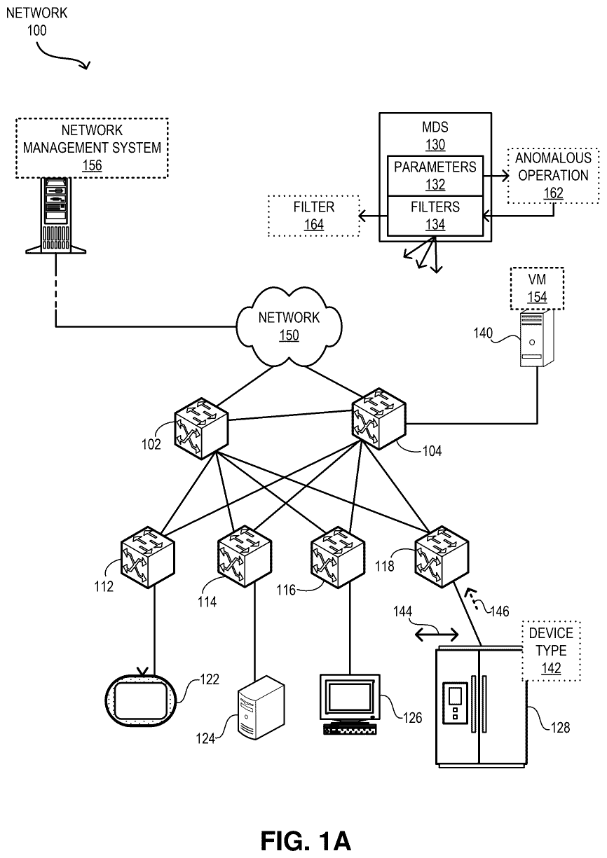

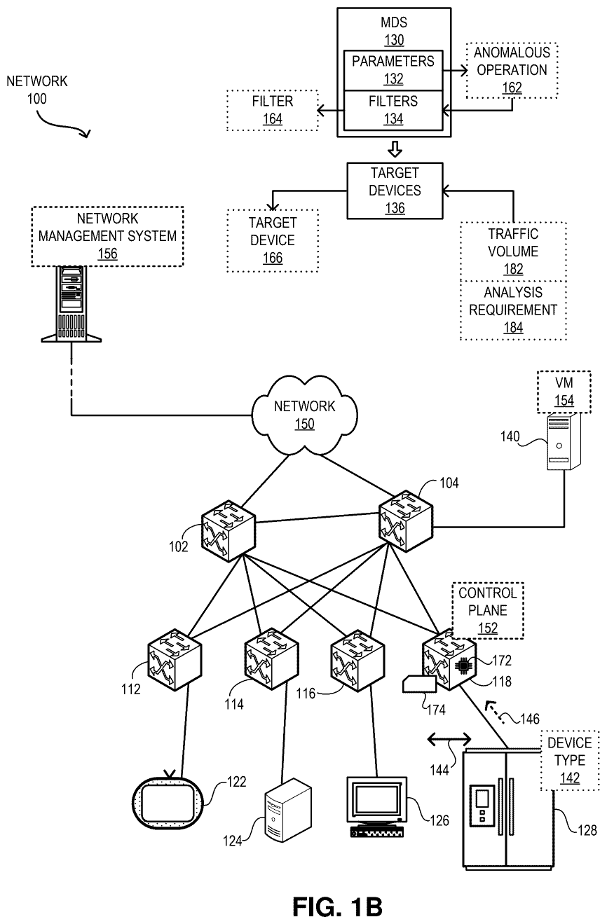

FIG. 1A illustrates an example of a network supporting dynamic anomaly detection and filtering for traffic mirroring, in accordance with an aspect of the present application. A network 100 can include a number of network devices (e.g., switches), and may include network components, such as layer-2 and layer-3 hops, and tunnels. In some examples, network 100 can be an Ethernet network, InfiniBand network, or other network, and may use a corresponding communication protocol, such as Internet Protocol (IP), FibreChannel over Ethernet (FCOE), or other protocol. Network 100 can include a number of network devices 102, 104, 112, 114, 116, and 118. A respective network device in network 100 can be associated with a MAC address and an IP address and can include at least one processing resource. Examples of a processing resource can include, but are not limited to, a processor core, a graphics processing unit (GPU), and a tensor processing unit (TPU).

Network devices 102 and 104 can be coupled to an external network 150 (e.g., the Internet). Network 100 may support a large number of user devices (e.g., IoT devices, laptops, and tablets). For example, user devices 122, 124, 126, and 128 can be coupled to network devices 112, 114, 116, and 118, respectively. In network 100, network devices 102 and 104 can operate as aggregation devices that can aggregate traffic from user devices 122, 124, 126, and 128 via network devices 112, 114, 116, and 118. Network devices 102 and 104 can then forward the aggregated traffic to external network 150. Similarly, traffic from external network 150 can be forwarded by network devices 102 and 104 to user devices 122, 124, 126, and 128. Network 100 can be managed by an NMS 156, such as a network orchestrator. NMS 156 can configure and provision a respective network device in network 100.

In this example, user device 122 can be a multicast client (e.g., a smart television), user device 124 can be a multicast source (e.g., a multicast server), user device 126 can be a personal device (e.g., a desktop, laptop, or tablet), and user device 128 can be an IoT device (e.g., a smart refrigerator). Some of these devices may not have sophisticated security measures and can be compromised. In addition, network devices of network 100 may be misconfigured. Consequently, both user devices and network devices may operate anomalously and may generate high volumes of anomalous traffic. Such anomalous operations may cause issues, such as packet loss due to overutilization of resources and network delays in network 100 due to extensive queueing.

Existing anomaly detection tools may detect these issues, such as packet loss and delay, in network 100 but not the anomalous operations, such as anomalous traffic generation, which lead to the issue. Consequently, prior to detecting the issue, these tools may not be able to dynamically define a filter to identify a particular data flow or device in network 100 that may have operated anomalously. Once the issue is detected, these tools can mirror traffic of multiple data flows, which are often selected by an administrator, from a network device and forward the mirrored traffic to a target device, such as NMS 156 or a VM 154. Here, VM 154 can run on server 140 and may be dedicated to the analysis of mirrored network traffic. In this example, server 140 can coupled to a network device of network 100, such as network device 102. However, server 140 can be reachable via external network 150. Therefore, the traffic mirroring operation may not be dynamically initiated before the issue is detected in network 100 and may not be specific to the data flow causing the issue.

To address this problem, network devices 102, 104, 112, 114, 116, and 118 can be enhanced to perform dynamic traffic analysis. In some examples, each of these network devices can be equipped with a traffic analysis tool that can perform dynamic traffic analysis. Each network device 102, 104, 112, 114, 116, and 118 can maintain respective sets of condition parameters 132 associated with expected anomalous operations of user devices 122, 124, 126, and 128. These anomalous operations can correspond to atypical movement and packet-generation patterns of individual user device types. Condition parameters 132 of a respective anomalous operation can then indicate the conditions associated with the atypical movement and packet-generation patterns of a particular type of user device.

Since user device 128 can be a smart appliance, device type 142 of user device 128 can be an IoT device. Since an IoT device, such as a smart refrigerator, is mostly stationary, an atypical movement pattern 144 of user device 128 (i.e., an IoT device) can include a number of migrations within a period exceeding a threshold. For example, for a stationary IoT device, user device 128 moving more than once per minute can indicate an atypical movement for user device 128. The number of migrations can be determined based on the number of times network device 118 has learned the layer-2 address (e.g., the MAC address) of user device 128 within the period. Similarly, an atypical traffic pattern 146 for user device 128 can be the generation of known types of high-volume traffic, such as video streaming, since a smart appliance is not typically used for video streaming. Here, traffic pattern 146 can indicate the type and volume of traffic generated by user device 128.

A traffic analyzer, which can inspect the content of individual packets, can be deployed on a respective network device. The traffic analyzer can be an application (e.g., a piece of software), such as NetFlow Analyzer, Wireshark, and Netfort, running on the network device. The traffic analyzer can determine the type and volume of traffic corresponding to traffic pattern 146. For example, the traffic analyzer running on network device 118 may determine that a set of packets received from user device 128 includes a data stream encoded with Moving Picture Experts Group transport stream (MPEG-TS). The network analyzer can determine the presence of protocol parameters associated with MPEG-TS, which are typically known to a traffic analyzer, in the packets and determine that the type of the packets corresponds to a video stream. Similarly, the traffic analyzer can determine that there are 1500 bytes in the payload of the packets.

Based on the number of packets in the set of packets and the number of bytes in each packet, the traffic analyzer can determine the volume of the traffic. In this way, the traffic analyzer can determine traffic pattern 146 associated with the traffic from user device 118. A respective network device, such as network device 118, can monitor the monitoring parameters indicating the movement pattern 144 and traffic pattern 146 at the network device. In this example, the monitoring parameters associated with movement pattern 144 can be the number of migrations since movement pattern 144 is determined based on the number of migrations of user device 128. Furthermore, the monitoring parameters associated with traffic pattern 146 can be the packet sizes generated by user device 128. Condition parameters 132 can then include the threshold number of migrations and the packet sizes indicating high-volume traffic (e.g., 1500 bytes of Ethernet payload).

Each of network devices 102, 104, 112, 114, 116, and 118 can store an MDS 130. MDS 130 can be stored in the forwarding hardware (e.g., in the TCAM) of the corresponding network device. A respective entry of MDS 130 can map condition parameters 132 of the anomalous operations to a set of traffic filters 134. A respective filter can indicate which data flow, device, or traffic type to be mirrored based on the filtering. For example, condition parameters 132 can include a threshold number of migrations. The corresponding traffic filter can include filtering based on MAC addresses and protocol ports. During operation, a respective network device, such as network device 118, can monitor the monitoring parameters associated with movement pattern 144 and traffic pattern 146 for device type 142 and compare the monitoring parameters with condition parameters 132. In this example, network device 118 can compare the number of migrations within a predetermined period, as indicated by the monitoring parameters associated with user device 128, with the threshold number of migrations, as indicated by condition parameters 132. If the number of migrations matches condition parameters 132, network device 118 can start filtering traffic based on the MAC address of user device 128 and the protocol ports it has been using.

Based on the comparison, network device 128 can determine whether movement pattern 144 and traffic pattern 146 of device type 142 match an anomalous operation. In this example, if user device 128's migration exceeds the threshold number of migrations (e.g., more than one migrations per minute), network device 118 can determine that user device 128 is migrating frequently for a device type 142. Furthermore, if the packet sizes of user device 128 are large, network device 118 can determine that user device 128 is generating high-volume traffic, such as video, for a device type 142. For example, if network device 118 generates a sequence of packets with the maximum Ethernet packet size (e.g., N packets of 1500 bytes), network device 128 can determine that network device 118 is generating large packets. If network device 118 determines that the monitoring parameters associated with movement pattern 144 and traffic pattern 146 match condition parameters 132, it can indicate an atypical pattern for device type 142. Subsequently, network device 118 can determine the entry that indicates frequent migration (indicated by movement pattern 144) or heavy traffic (indicated by traffic pattern 146) for device type 142 (e.g., an IoT device) in MDS 130. Network device 118 can then determine an anomalous operation 162 represented by the combination of movement pattern 144 and traffic pattern 146.

Subsequently, network device 118 can select a filter 164 mapped to the combination of the combination of movement pattern 144 and traffic pattern 146 (i.e., corresponding to anomalous operation 162) in MDS 130. Network device 118 can then apply filter 164 to mirror the relevant subset of traffic from user device 128 to a corresponding target device, such as NMS 156 or VM 154. As described above, if movement pattern 144 indicates a frequent migration of an IoT device, network device 118 can filter traffic associated with the MAC address of the IoT device and the protocol port of the traffic from the IoT device. Here, filter 164 can select the subset of traffic that includes the MAC address and the protocol port from all traffic at network device 118. In some examples, filter 164 can be determined based on Linux Socket Filtering or Berkeley Packet Filter (BPF). Here, the mirroring of the traffic selected by filter 164 can be initiated prior to detecting an issue with network device 118 or user device 128 (e.g., utilization of resources, delay, or packet drops at network device 118). In this way, network device 118 can start traffic analysis of the relevant traffic during the anomalous operation of user device 128 before the issue has occurred in network 100.

FIG. 1B illustrates an example of a network supporting dynamic selection of a target device for mirrored traffic, in accordance with an aspect of the present application. Currently, the target device for a tool deployed in network 100 can be predetermined. As a result, mirrored traffic related to all types of anomalies may be forwarded to a particular target device. For example, all anomalous traffic detected at network devices 102, 104, 112, 114, 116, and 118 can be forwarded to NMS 156 for further analysis. Consequently, NMS 156 can become overutilized. Furthermore, if NMS 156 is selected as the target device, a network administrator may analyze a substantial volume of network traffic at NMS 156 to identify the cause of the issue, which can be tedious and error prone.

To address this issue and further enhance the network analysis process, network device 118 can dynamically select the target device from a set of available target devices 136. Each of network devices 102, 104, 112, 114, 116, and 118 can maintain a list of target devices 136. At network device 118, the list of target devices 136 can include network device 118, VM 154, and NMS 156. If network device 118 is selected, the filtered traffic is mirrored to processing resources 172 of network device 118. Filtering traffic to processing resources 172 can include a network analysis application running on processing resources 172. Examples of processing resources 172 can include, but are not limited to, a CPU, a GPU, and an accelerator. For NMS 156, the list can also indicate whether to mirror traffic to NMS 156 via processing resources 172 or a dedicated network interface card or controller (NIC) 174 of network device 118.

Upon detecting anomalous operation 162, network device 118 can determine filter 164 mapped to anomalous operation 162 in MDS 130. Network device 118 can then dynamically select a target device 166 from the list of target devices 136. Subsequently, network device 118 can start mirroring traffic selected by filter 164 to target device 166 (e.g., traffic comprising the MAC address of user device 128). Network device 118 can select target device 166 based on traffic volume 182 of the mirrored traffic selected by filter 164 and analysis requirement 184 of anomalous operation 162. For example, if high-volume traffic, such as video traffic, is selected by filter 164, traffic volume 182 of filtered traffic can be high. Furthermore, analysis requirement 184 can indicate whether extensive manual analysis of the mirrored traffic by an administrator is needed. Analysis requirement 184 can be predetermined by the administrator and may be indicated in the corresponding entry in MDS 130. By dynamically selecting target device 166, network device 118 can efficiently perform network traffic analysis without overwhelming an individual target device in target device 136.

If traffic volume 182 is low and analysis requirement 184 does not indicate extensive analysis, target device 166 can be network device 118. For example, if a frequently migrating IoT device sends low-volume control traffic of a protocol, the traffic can be filtered based on the MAC address of the IoT device and the protocol port associated with the protocol. If the administrator indicates in analysis requirement 184 that further analysis is not required for the low-volume filtered traffic, the mirrored traffic can be sent to the local control plane of network device 118. The control plane can operate on one or more processing resources 172 of network device 118. In particular, since processing resource 172 can perform other operations for network device 118, traffic volume 182 can be low. The maximum threshold traffic volume allowed to be forwarded to processing resources 172 can be predetermined (e.g., N Mbps) by an administrator and configured on network device 118. Processing resources 172 is selected as target device 166 if traffic volume 182 is lower than the threshold traffic volume.

Moreover, if traffic volume 182 is high (e.g., higher than the threshold traffic volume) and analysis requirement 184 does not indicate extensive analysis, target device 166 can be VM 154. For example, if a multicast source of a multicast group migrates frequently, the traffic can be filtered based on the MAC address of the multicast source, the multicast IP address of the multicast group, and the multicast traffic. The filtered traffic can be high-volume traffic since multicast traffic often includes video streams. If the administrator indicates in analysis requirement 184 that further analysis is not required for the high-volume filtered traffic, the filtered traffic can be forwarded to VM 154. VM 154 may also be selected if filter 164 is a limited filter that mirrors traffic based on one or two conditions (e.g., MAC addresses and protocol type).

If traffic from a user host suddenly increases or decreases, the traffic can be filtered based on the MAC address of the user host. If the administrator indicates in analysis requirement 184 that the mirrored traffic does not require extensive analysis, target device 166 can be VM 154.

Furthermore, if traffic volume 182 is low and analysis requirement 184 indicates extensive analysis, target device 166 can be NMS 156 via processing resources 172. Since traffic volume 182 can be low, processing resources 172 can forward the traffic to NMS 156 without interrupting other services. Therefore, limited hardware resources of network device 118, such as NIC 174, may not be used for mirroring. On the other hand, if traffic volume 182 is high and analysis requirement 184 indicates extensive analysis, target device 166 can be NMS 156 via NIC 174.

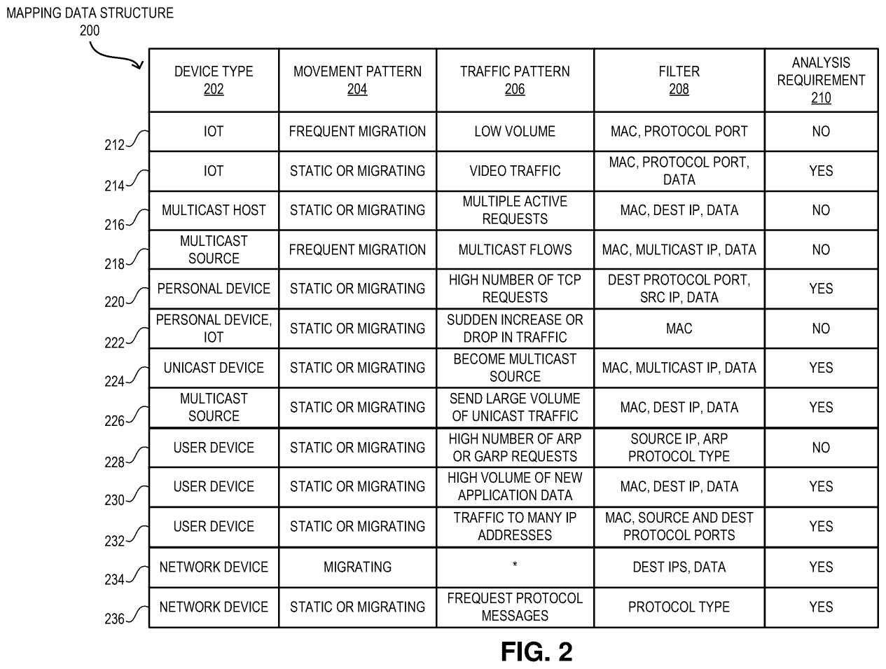

FIG. 2 illustrates an example of a mapping data structure for supporting dynamic anomaly detection and filtering, in accordance with an aspect of the present application. An NMS 200 can be deployed in a respective network device of a network. NSM 200 can correspond to NMS 130 of FIGS. 1A and 1B. NMS 200 can include a plurality of entries, each indicating an anomalous operation for a device type 202. The anomalous operation is indicated by a movement pattern 204 and a traffic pattern 206. The combination of device type 202, movement 204, and traffic pattern 206 can be mapped to a filter 208, which can indicate the subset of traffic that should be mirrored for the anomalous operation. In some examples, a respective entry also include an analysis requirement 210, which can indicate whether extensive analysis is needed for the corresponding anomalous operation.

IoT devices typically generate low-volume traffic as are not expected to send or receive video traffic. Furthermore, IoT devices are mostly stationary. For example, an IoT device can be a smart refrigerator that sends or receives low-volume control traffic (e.g., for setting temperatures of the refrigerator). Accordingly, entries 212 and 214 of MDS 200 can indicate anomalous operations of IoT devices. Entry 212 can indicate that an IoT device migrating frequently and generating low-volume traffic can correspond to an anomalous operation. The network device can then filter traffic based on the MAC address and the protocol port (e.g., a layer-4 or transport layer port, such as a Transmission Control Protocol (TCP) port). The mirrored traffic may not require extensive analysis. Similarly, entry 214 can indicate that an IoT device, which can be static or migrating, generating video traffic can indicate an anomalous operation. If a device can be static or migrating, the associated anomalous operation can be detected regardless of the movement pattern. For example, if an IoT device, such as a smart refrigerator, starts sending multicast traffic, regardless of its movement pattern, an anomalous operation for the IoT device can be detected. The network device can filter traffic based on the MAC address, protocol port, and corresponding data (e.g., the payload). Since the type of data may need to be further analyzed, the mirrored traffic can then require extensive analysis.

Entry 216 can indicate that a multicast host, such as an IP television (IPTV) client, which can be static or migrating, may not have multiple active channel requests. For example, the device may request one channel at a time and hence, may not send more than one join request without sending a corresponding leave. The network device can then filter traffic based on the MAC address, destination IP address, and corresponding data. The mirrored traffic may not require extensive analysis. Furthermore, a fast-moving device typically does not operate as an IPTV source. Therefore, entry 218 can indicate that if a static or migrating multicast source is frequently migrating and sending multicast data flows, the relevant traffic should be filtered based on the MAC address, multicast IP address, and corresponding data. The mirrored traffic may not require extensive analysis.

Furthermore, entry 220 can indicate that if a static or migrating personal device sends a high number of TCP requests over a period, the relevant traffic should be filtered for mirroring based on the destination protocol port, source IP address, and corresponding data. A device can be detected as a personal device based on the MAC address of the device when connected to a network. The administrator may configure a threshold number of TCP connections (e.g., five and ten TCP connections per second for IoT and personal devices (e.g., a laptop), respectively), and if the number of TCP connections exceeds the threshold number, the network device may determine that the personal device is generating a high number of TCP requests. The mirrored traffic may require extensive analysis. In addition, MDS 200 may include entries indicating anomalous operations associated with other protocols (not shown in FIG. 2). The administrator may configure respective thresholds for these protocols (e.g., five and ten name lookup queries or IP address requests per second for IoT and personal devices (e.g., a laptop), respectively).

Entry 222 can indicate an anomalous operation associated with a sudden increase or drop in traffic. For example, an IoT device may generate traffic infrequently. Here, an IoT device can be a smart refrigerator that sends or receives infrequent control traffic when a user interacts with the smart refrigerator. Hence, generating traffic frequently can be an anomalous operation for an IoT device. Accordingly, entry 222 can indicate that if a static or migrating personal device or IoT device has a sudden increase or drop in traffic (e.g., a device typically receiving web traffic suddenly receiving video traffic), the relevant traffic (i.e., traffic that might be relevant to an anomalous operation) should be filtered for mirroring based on the MAC address of the device. The mirrored traffic may not require extensive analysis. Furthermore, a unicast device (i.e., a user device sending and receiving unicast traffic) typically does not become a multicast source. Entry 224 indicates that if a static or migrating unicast client has become a multicast source, the relevant traffic should be filtered for mirroring based on the MAC address, multicast IP address, and corresponding data. The mirrored traffic may require extensive analysis.

Furthermore, a multicast source, such as a multicast server, usually does not send a large volume of unicast data. Entry 226 can indicate that if a static or migrating multicast source sends a large volume of unicast traffic, the relevant traffic should be filtered for mirroring based on the MAC address, destination IP address, and corresponding data. The mirrored traffic may require extensive analysis. Moreover, entry 228 can indicate that if a static or migrating user device sends a high number of Address Resolution Protocol (ARP) or gratuitous ARP (GARP) requests over a period, the relevant traffic should be filtered for mirroring based on the source IP address and ARP protocol type. The administrator may configure a threshold number of ARP or GARP requests (e.g., two and ten ARP requests per second for IoT and personal devices, respectively), and if the number of ARP or GARP requests exceeds the threshold number, the network device may determine that the personal device is generating a high number of ARP or GARP requests. The mirrored traffic may not require extensive analysis.

Another anomalous operation of a user device can be caused based on a change in application data. For example, a user device may typically access a particular class of traffic (e.g., a video-sharing application or social media). However, if the user device starts accessing a high volume of data of another application, it can be indicative of an anomalous operation. Hence, entry 230 can indicate that if a static or migrating user device accesses a high volume of new application data, the relevant traffic should be filtered for mirroring based on the MAC address, destination IP address, and corresponding data. The mirrored traffic may require extensive analysis. In addition, if a particular device sends traffic to a large number of other devices, it can be indicative of an anomalous operation. Corresponding entry 232 can indicate that if a static or migrating user device sends traffic to many IP addresses (e.g., more than a predefined threshold number of IP addresses), the relevant traffic should be filtered for mirroring based on the MAC address and the source and destination protocol ports. The mirrored traffic may require extensive analysis.

In addition to user devices, the network devices may also behave anomalously. For example, a network device can typically be stationary and hence, a migrating network device can be indicative of an anomalous behavior. Another network device may repeatedly learn the MAC address of the network device and determine that the network device is migrating. Accordingly, entry 234 can indicate that, regardless of traffic (denoted with a “*”), if a network device migrates, the relevant traffic should be filtered for mirroring based on the destination IP addresses and corresponding data. The mirrored traffic may require extensive analysis.

Moreover, a network device sending frequent protocol messages, such as route updates or adjacency advertisements associated with a routing protocol, can be indicative of an anomalous operation. An administrator may configure threshold frequency for individual protocols (e.g., one control message per second for a routing protocol). The frequency of protocol messages exceeding the corresponding threshold frequency, which can be defined by an administrator, can indicate an anomalous operation. Hence, entry 236 can indicate that if a static or migrating network device generates frequent protocol messages, the relevant traffic should be filtered for mirroring based on the protocol type associated with the protocol messages. The mirrored traffic may require extensive analysis.

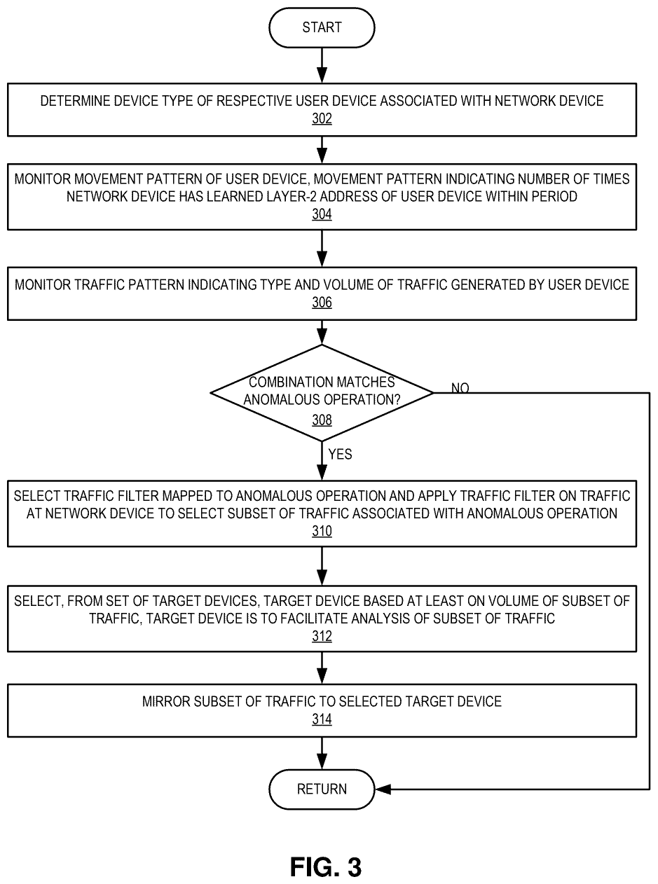

FIG. 3 presents a flowchart illustrating an example of a process of a network device facilitating dynamic network traffic analysis, in accordance with an aspect of the present application. During operation, the network device can determine a device type of a respective user device associated with a network device (operation 302). The device type can be an IoT device, a multicast source (e.g., sending multicast data via the network device), a multicast host (e.g., sending multicast join requests via the network device), etc. In the example of FIG. 1A, network device 118 can determine that device type 142 of user device 128. The network device can then monitor the movement pattern of the user device (operation 304). Here, the movement pattern can indicate a number of times the network device has learned the layer-2 address of the user device within a period (operation 306). The period can be predefined by an administrator. The movement pattern (e.g., movement pattern 144 of user device 118 in FIG. 1A) can indicate how frequently the user device has been moving.

The network can also monitor the traffic pattern (e.g., movement pattern 146 of user device 118 in FIG. 1A), which can indicate the type and volume of traffic generated by the user device (operation 306). The type of traffic can indicate whether the traffic is unicast or multicast traffic. The volume of traffic can be the number of bytes generated within a period. The network device can then determine whether the combination of the device type, movement pattern, and traffic pattern matches an anomalous operation (operation 308). The network device can maintain an MDS that can indicate a set of condition parameters that can indicate corresponding anomalous operations for a particular device type (e.g., device type 202, movement pattern 204, and traffic pattern 206 in MDS 200 of FIG. 2). If the movement pattern and traffic pattern match the condition parameters of an anomalous operation of a device type, the network device can detect the corresponding anomalous operation.

If the combination matches an anomalous operation, the network device can select a traffic filter mapped to the anomalous operation and apply the traffic filter on the traffic at the network device to select a subset of traffic associated with the anomalous information (operation 310). The anomalous operation can be indicated by the combination of the device type, movement pattern, and traffic pattern of the anomalous operation. Therefore, the filter can be mapped to this combination. In the example in FIG. 2, the combination of device type 202, movement pattern 204, and traffic pattern 206 can be mapped to filter 208 in MDS 200. Furthermore, in the example in FIG. 1A, network device 118 can determine anomalous operation 162 associated with user device 128 and determine filter 164 mapped to anomalous operation 162. By applying the selected filter, the network device can determine which traffic should be mirrored from the network device.

The network device can also select, from a set of target devices, the target device based at least on the volume of the subset of traffic (operation 312). Here, the target device can facilitate the analysis of the subset of traffic selected by the filter. In the example in FIG. 1B, network device 118 can select target device 166 from target devices 136 based on traffic volume 182. Subsequently, the network device can mirror the subset of traffic to the selected target device (operation 314). Mirroring the traffic can include generating a copy of a respective packet in the subset of traffic and sending the packet to the target device. An administrator may perform subsequent analysis of the copies packets at target device 166.

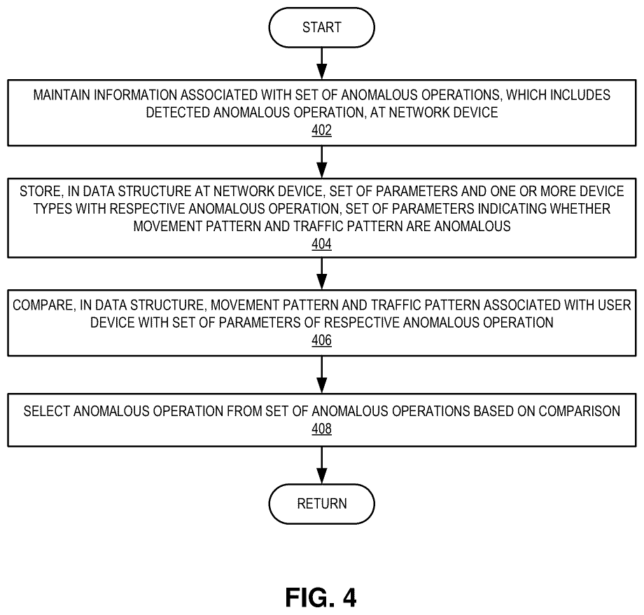

FIG. 4 presents a flowchart illustrating an example of a process of a network device dynamically detecting an anomalous operation, in accordance with an aspect of the present application. During operation, the network device can maintain information associated with a set of anomalous operations, which includes the detected anomalous operation (i.e., the anomalous operation of FIG. 3), at the network device (operation 402). The information can include the condition parameters indicating the anomalous operation. Accordingly, the network device can store, in a data structure (e.g., MDS 200 in FIG. 2), a set of parameters and one or more device types with a respective anomalous operation (operation 404). Here, the set of parameters can indicate whether the movement pattern and traffic pattern are anomalous. This set of parameters can be the condition parameters against which the monitoring parameters of the movement pattern and traffic pattern can be compared, as described in conjunction with FIG. 1A.

Hence, the network device can compare, in the data structure, the movement pattern and traffic pattern associated with a user device with the set of parameters of a respective anomalous operation (operation 406). The network device can select the anomalous operation from the set of anomalous operations based on the comparison (operation 408). In the example in FIG. 1A, movement pattern 144 of user device 128 can be determined based on a monitoring parameter indicating the number of migrations of user device 128 at network device 118. Furthermore, traffic pattern 146 of user device 128 can be determined based on another monitoring parameter indicating the packet sizes. These monitoring parameters can then be compared with the set of parameters (e.g., condition parameters 132), which may include a threshold number of migrations and a threshold packet size. Based on the comparison, network device 118 can select anomalous operation 162.

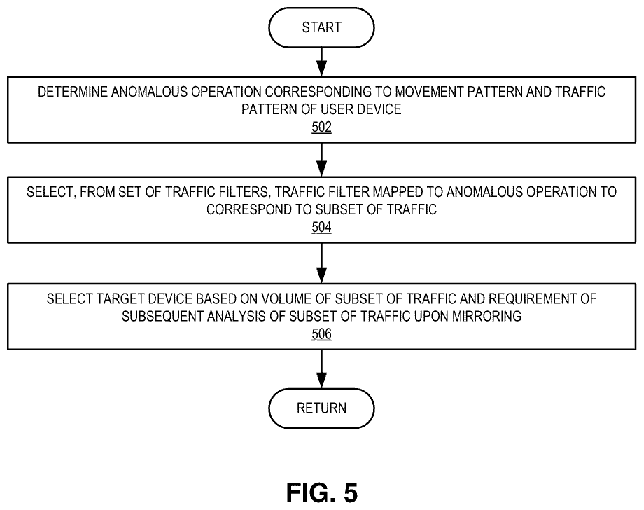

FIG. 5 presents a flowchart illustrating an example of a process of a network device dynamically selecting a target device for mirrored traffic, in accordance with an aspect of the present application. During operation, the network device can determine the anomalous operation corresponding to the movement pattern and traffic pattern associated with a user device (operation 502). Here, the movement pattern and traffic pattern can indicate whether an anomalous operation is determined for the user device. The network device can then select, from the set of traffic filters, a traffic filter mapped to the anomalous operation to correspond to the subset of traffic (operation 504). In the example in FIG. 2, the network device can determine whether the monitoring parameters associated with the user device match the condition parameters corresponding to movement pattern 204 and traffic pattern 206 of MDS 200. If a match is found in an entry, the network device can then select filter 208 mapped in the entry.

The network device can then select the target device based on the volume of the subset of traffic and the requirement of subsequent analysis of the subset of traffic upon mirroring (operation 506). In the example in FIG. 1B, network device 118 can select filter 164 based on traffic volume 182 and analysis requirement 184. Here, the requirement of subsequent analysis can be predetermined by an administrator and can be indicated in the data structure of FIG. 4. In the example in FIG. 2, for a respective combination of device type 202, movement pattern 204, traffic pattern 206, and filter 208, MDS 200 can also indicate an analysis requirement 210. Here, analysis requirement 210 can indicate whether significant analysis by an administrator is needed on the mirrored traffic selected by filter 208.

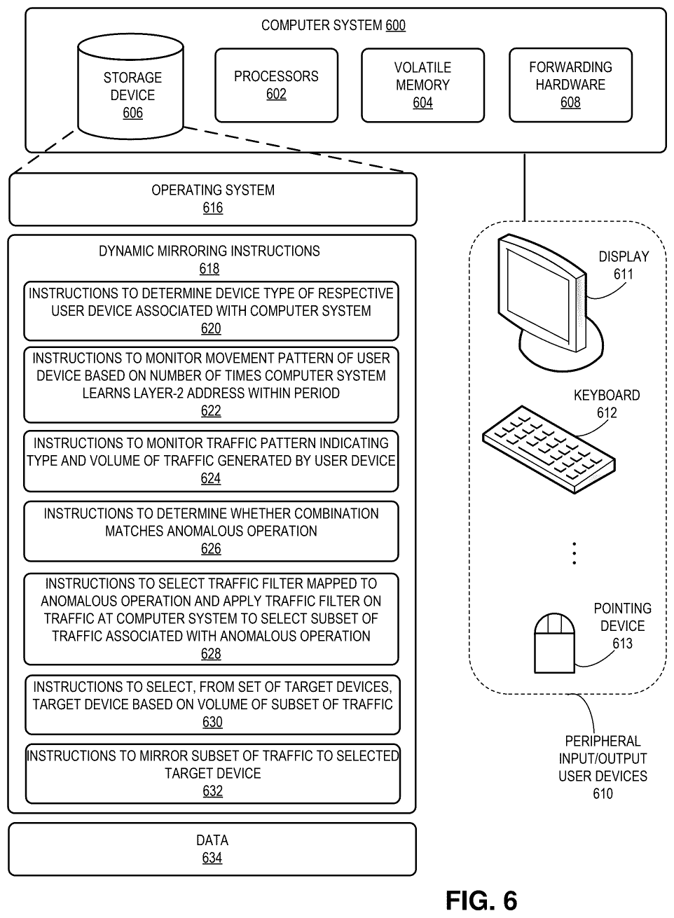

FIG. 6 illustrates an example of a computing system facilitating dynamic network traffic analysis, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). forwarding hardware 608 can include a TCAM. Storage device 606 includes a non-transitory computer-readable storage medium and stores an operating system 616, flow-management instructions 618, and data 634. Computer system 600 may include fewer or more entities or instructions than those shown in FIG. 6.

Dynamic mirroring instructions 618 can include instructions, which when executed by computer system 600, can cause computer system 600 to perform methods and/or processes described in this disclosure. Specifically, dynamic mirroring instructions 618 may include instructions 620 to determine the device type associated with a respective user device associated with computer system 600. In the example in FIG. 1A, computer system 600 can correspond to network device 118, which can determine device type 142 of user device 128. Dynamic mirroring instructions 618 may also include instructions 622 to monitor the movement pattern of the user device based on the number of times computer system 600 learns the layer-2 address within a period. Movement pattern 144 of user device 128 of FIG. 1A can be an example of the movement pattern.

Furthermore, dynamic mirroring instructions 618 may also include instructions 624 to monitor the traffic pattern indicating the type and volume of traffic generated by the user device. For example, network device 118 of FIG. 1A can determine traffic pattern 146 of user device 128. Dynamic mirroring instructions 618 can also include instructions 626 to determine whether the combination of the device type, movement pattern, and traffic pattern matches an anomalous operation. In the example in FIG. 1A, the combination of device type 142, movement pattern 144, and traffic pattern 146 can match anomalous operation 162 in MDS 132.

If the combination matches the anomalous operation, dynamic mirroring instructions 618 may include instructions 628 to select a filter mapped to the anomalous operation and apply the traffic filter on the traffic at computer system 600 to select the subset of traffic associated with the anomalous operation. Network device 118 of FIG. 1A can select filter 164 mapped to anomalous operation 162 in MDS 130 and apply filter 164 to select the subset of traffic relevant to anomalous operation 162.

Dynamic mirroring instructions 618 may also include instructions 630 to select, from a set of target devices, the target device based at least on the volume of the subset of traffic. Upon selecting filter 164, network device 118 of FIG. 1B can select target device 166 from a set of target devices 136 based on traffic volume 182. Furthermore, dynamic mirroring instructions 618 may also include instructions 632 to mirror traffic to the selected target device. In the example in FIG. 1B, network device 118 can mirror the subset of traffic selected by filter 164 to target device 166.

Data 634 can include any data that is required as input, or that is generated as output by the methods, operations, communications, and/or processes described in this disclosure. Specifically, data 634 can include monitoring parameters associated with the movement pattern and traffic pattern of the user device, condition parameters associated with an anomalous operation, and an MDS mapping an anomalous operation to a corresponding filter and analysis requirement.

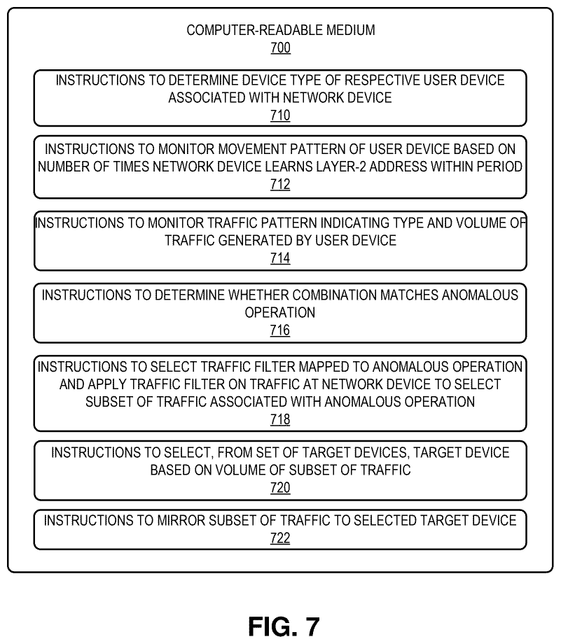

Computer system 600 and dynamic mirroring instructions 618 may include more instructions than those shown in FIG. 6. For example, dynamic mirroring instructions 618 can also store instructions for comparing monitoring parameters of movement pattern 144 and traffic pattern 146 with condition parameters 132 of FIG. 1A; mirroring traffic to NMS 156 via processing resources 172 or NIC 174 of FIG. 1B; forwarding multicast traffic of the multicast group before receiving or processing a new network join request of FIG. 1B; determining anomalous operations based on the combination of device type 202, movement pattern 204, and traffic pattern 206 of FIG. 2; and the operations depicted in the flowcharts of FIGS. 3, 4A-4B, and 5; and the instructions of non-transitory CRM 700 in FIG. 7.

FIG. 7 illustrates an example of a CRM facilitating dynamic network traffic analysis, in accordance with an aspect of the present application. CRM 700 can include one or more non-transitory computer-readable mediums or devices storing instructions that when executed by a computer or processor cause the computer or processor to perform a method. Therefore, the instructions in CRM 700 can be stored in one or more non-transitory computer-readable mediums or devices. CRM 700 can store instructions 710 to determine the device type associated with a respective user device associated with a network device. In the example in FIG. 1A, network device 118 can determine device type 142 of user device 128.

CRM 700 can also include instructions 712 to monitor the movement pattern of the user device based on the number of times the network device learns the layer-2 address within a period. Movement pattern 144 of user device 128 of FIG. 1A can be an example of the movement pattern. CRM 700 can include instructions 714 to monitor the traffic pattern indicating the type and volume of traffic generated by the user device. For example, network device 118 of FIG. 1A can determine traffic pattern 146 of user device 128.

CRM 700 can additionally include instructions 716 to determine whether the combination of the device type, movement pattern, and traffic pattern matches an anomalous operation. In the example in FIG. 1A, the combination of device type 142, movement pattern 144, and traffic pattern 146 can match anomalous operation 162 in MDS 132. Moreover, CRM 700 can include instructions 718 to select a filter mapped to the anomalous operation and apply the traffic filter on the traffic at the network device to select the subset of traffic associated with the anomalous operation. Network device 118 of FIG. 1A can select filter 164 mapped to anomalous operation 162 in MDS 130 and apply filter 164 to select the subset of traffic relevant to anomalous operation 162.

Furthermore, CRM 700 can include instructions 720 to select, from a set of target devices, the target device based at least on the volume of the subset of traffic. Upon selecting filter 164, network device 118 of FIG. 1B can select target device 166 from a set of target devices 136 based on traffic volume 182. CRM 700 can also include instructions 722 to mirror traffic to the selected target device. In the example in FIG. 1B, network device 118 can mirror the subset of traffic selected by filter 164 to target device 166.

CRM 700 may include more instructions than those shown in FIG. 7. For example, CRM 700 can also store instructions for comparing monitoring parameters of movement pattern 144 and traffic pattern 146 with condition parameters 132 of FIG. 1A; mirroring traffic to NMS 156 via processing resources 172 or NIC 174 of FIG. 1B; forwarding multicast traffic of the multicast group before receiving or processing a new network join request of FIG. 1B; determining anomalous operations based on the combination of device type 202, movement pattern 204, and traffic pattern 206 of FIG. 2; and the operations depicted in the flowcharts of FIGS. 3, 4A-4B, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in a network. During operation, the network device can determine a device type of a respective user device associated with the network device. The network device can monitor a movement pattern of the user device. The movement pattern can indicate the number of times the network device has learned a layer-2 address of the user device within a period. The network device can also monitor a traffic pattern indicating a type and a volume of traffic generated by the user device. The network device can then determine whether a combination of the device type, the movement pattern, and the traffic pattern matches an anomalous operation. If the combination matches the anomalous operation, the network device can select a traffic filter mapped to the anomalous operation and apply the traffic filter on the traffic at the network device to select a subset of the traffic associated with the anomalous operation. The network device can then select, from a set of target devices, a target device based at least on a volume of the subset of the traffic and mirror the subset of the traffic to the target device. Here, the target device can facilitate analysis of the subset of the traffic.

In a variation on this aspect, the network device can maintain information associated with a set of anomalous operations, which includes the determined anomalous operation, at the network device. A respective anomalous operation can be mapped to a combination of a corresponding movement pattern and a corresponding traffic pattern.

In a further variation, the network device can maintain the information associated with the set of anomalous operations by storing, in a data structure at the network device, a set of parameters and one or more device types with a respective anomalous operation. Here, the set of parameters can indicate whether the movement pattern and the traffic pattern are anomalous.

In a further variation, the network device can compare, in the data structure, the movement pattern and the traffic pattern associated with the user device with the set of parameters of the respective anomalous operation. The network device can then select the anomalous operation from the set of anomalous operations based on the comparison.

In a variation on this aspect, the network device can compare the movement pattern and the traffic pattern with a set of traffic filters maintained at the network device. The network device can then select, from the set of traffic filters, the traffic filter to correspond to the subset of the traffic.

In a variation on this aspect, the network device can select the target device based further on a requirement of subsequent analysis of the mirrored traffic.

In a variation on this aspect, the set of target devices for mirroring the subset of the traffic comprises one or more of: a processing resource of the network device, a remote virtual machine (VM), a network management system via the processing resource, and the network management system via a network interface controller (NIC) of the network device.

In a variation on this aspect, the mirroring of the subset of the traffic can be initiated prior to detecting an issue with the network device. The issue can correspond to the utilization of resources, delay, or packet drops at the network device.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What Is Claimed Is:

1. A method, comprising:
determining, by a network device in a network, a device type of a respective user device associated with the network device;
monitoring, by the network device, a movement pattern of the user device, the movement pattern indicating a number of times the network device has learned a layer-2 address of the user device within a period;
monitoring, by the network device, a traffic pattern indicating a type and a volume of traffic generated by the user device;
determining whether a combination of the device type, the movement pattern, and the traffic pattern matches an anomalous operation; and
in response to the combination matching the anomalous operation:
selecting a traffic filter mapped to the anomalous operation;
applying the traffic filter on traffic at the network device to select a subset of the traffic associated with the anomalous operation;
selecting, from a set of target devices, a target device based at least on a volume of the subset of the traffic, the target device is to facilitate analysis of the subset of the traffic; and
mirroring the subset of the traffic to the target device.

2. The method of claim 1, further comprising maintaining information associated with a set of anomalous operations, which includes the determined anomalous operation, at the network device, wherein a respective anomalous operation is mapped to a combination of a corresponding movement pattern and a corresponding traffic pattern.

3. The method of claim 2, wherein maintaining the information associated with the set of anomalous operations further comprises storing, in a data structure at the network device, a set of parameters and one or more device types with a respective anomalous operation, wherein the set of parameters indicates whether the movement pattern and the traffic pattern are anomalous.

4. The method of claim 3, further comprising:
comparing, in the data structure, the movement pattern and the traffic pattern associated with the user device with the set of parameters of the respective anomalous operation; and
selecting the anomalous operation from the set of anomalous operations based on the comparison.

5. The method of claim 1, further comprising:
comparing the movement pattern and the traffic pattern with a set of traffic filters maintained at the network device; and
selecting, from the set of traffic filters, the traffic filter to correspond to the subset of the traffic.

6. The method of claim 1, further comprising selecting the target device based further on a requirement of subsequent analysis of the mirrored traffic.

7. The method of claim 1, wherein the set of target devices for mirroring the subset of the traffic comprises one or more of:
a processing resource of the network device;
a remote virtual machine (VM);
a network management system via the processing resource; and
the network management system via a network interface controller (NIC) of the network device.

8. The method of claim 1, wherein the mirroring of the subset of the traffic is initiated prior to detecting an issue with the network device, and wherein the issue corresponds to utilization of resources, delay, or packet drops at the network device.

9. A non-transitory computer-readable storage medium storing instructions to:
determine, by a network device in a network, a device type of a respective user device associated with the network device;
monitor, by the network device, a movement pattern of the user device, the movement pattern indicating a number of times the network device has learned a layer-2 address of the user device within a period;
monitor, by the network device, a traffic pattern indicating a type and a volume of traffic generated by the user device;
determine whether a combination of the device type, the movement pattern, and the traffic pattern matches an anomalous operation; and
in response to the combination matching the anomalous operation:
select a traffic filter mapped to the anomalous operation;
apply the traffic filter on traffic at the network device to select a subset of the traffic associated with the anomalous operation;
select, from a set of target devices, a target device based at least on a volume of the subset of the traffic, the target device is to facilitate analysis of the subset of the traffic; and
mirror the subset of the traffic to the target device.

10. The non-transitory computer-readable storage medium of claim 9, wherein the instructions are further to maintain information associated with a set of anomalous operations, which includes the determined anomalous operation, at the network device, wherein a respective anomalous operation is mapped to a combination of a corresponding movement pattern and a corresponding traffic pattern.

11. The non-transitory computer-readable storage medium of claim 10, wherein, to maintain the information associated with the set of anomalous operations, the instructions are further to store, in a data structure at the network device, a set of parameters and one or more device types with a respective anomalous operation, wherein the set of parameters indicates whether the movement pattern and the traffic pattern are anomalous.

12. The non-transitory computer-readable storage medium of claim 11, wherein the instructions are further to:
compare, in the data structure, the movement pattern and the traffic pattern associated with the user device with the set of parameters of the respective anomalous operation; and
select the anomalous operation from the set of anomalous operations based on the comparison.

13. The non-transitory computer-readable storage medium of claim 9, wherein the instructions are further to:
compare the movement pattern and the traffic pattern with a set of traffic filters maintained at the network device; and
select, from the set of traffic filters, the traffic filter to correspond to the subset of the traffic.

14. The non-transitory computer-readable storage medium of claim 9, wherein the instructions are further to select the target device based further on a requirement of subsequent analysis of the mirrored traffic.

15. The non-transitory computer-readable storage medium of claim 9, wherein the set of target devices for mirroring the subset of the traffic comprises one or more of:
a processing resource of the network device;
a remote virtual machine (VM);
a network management system via the processing resource; and
the network management system via a network interface controller (NIC) of the network device.

16. The non-transitory computer-readable storage medium of claim 9, wherein the mirroring of the subset of the traffic is initiated prior to detecting an issue with the network device, and wherein the issue corresponds to utilization of resources, delay, or packet drops at the network device.

17. A computer system, comprising:
one or more processing resources;
a non-transitory computer-readable storage medium storing instructions that when executed by the one or more processing resourced cause the computer system to:
determine a device type of a respective user device associated with the computer system in a network;
monitor a movement pattern of the user device, the movement pattern indicating a number of times the computer system has learned a layer-2 address of the user device within a period;
monitor a traffic pattern indicating a type and a volume of traffic generated by the user device;
determine whether a combination of the device type, the movement pattern, and the traffic pattern matches an anomalous operation; and
in response to the combination matching the anomalous operation:
select a traffic filter mapped to the anomalous operation;
apply the traffic filter on traffic at the computer system to select a subset of the traffic associated with the anomalous operation;
select, from a set of target devices, a target device based at least on a volume of the subset of the traffic, the target device is to facilitate analysis of the subset of the traffic; and
mirror the subset of the traffic to the target device.

18. The computer system of claim 17, wherein the instructions executed by the one or more processing resources cause the computer system further to maintain information associated with a set of anomalous operations, which includes the determined anomalous operation, at the network device, wherein a respective anomalous operation is mapped to a combination of a corresponding movement pattern and a corresponding traffic pattern.

19. The computer system of claim 18, wherein maintaining the information associated with the set of anomalous operations further comprising storing, in a data structure at the network device, a set of parameters and one or more device types with a respective anomalous operation, wherein the set of parameters indicates whether the movement pattern and the traffic pattern are anomalous.

20. The computer system of claim 19, wherein the instructions executed by the one or more processing resources cause the computer system further to:
compare, in the data structure, the movement pattern and the traffic pattern associated with the user device with the set of parameters of the respective anomalous operation; and
select the anomalous operation from the set of anomalous operations based on the comparison.
